(19) United States
(12) Patent Application Publication
(10) Pub. No.: US 2014/0123483 A1
(43) Pub. Date: May 8, 2014

(54) Creating an electric bicycle

(71) Applicants: Clinton J. Wilsey, Albuquerque, NM (US); John J. Cousins, Albuquerque, NM (US)

(72) Inventors: Clinton J. Wilsey, Albuquerque, NM (US); John J. Cousins, Albuquerque, NM (US)

(21) Appl. No.: 13/586,796

(22) Filed: Aug. 15, 2012

(51) Int. Cl. B62M 6/55; B62M 25/08

(52) U.S. Cl. CPC B62M 6/55; B62M 25/08
USPC 29/825; 29/745

(57) ABSTRACT

Disclosed is a system and method of encasing the drive components of an electric powered bicycle in a unified storage device compressed and structurally integrated into the triangle space between the top tube, down tube and seat tube of a typical bicycle frame. This invention details a unique component case that provides the storage and security of electric bicycle drive components including the electric power source (the battery cell pack), and electric motor controller including circuit board and housing, along with associated wires, fuses, switches, instruments and plugs. This invention also details a unique braking system and details a method of mounting stationary foot pegs in the bottom bracket of a typical frame and replacing the standard pedals and crank set.

### BACKGROUND OF THE INVENTION

1. Field of the Invention

The technical field to which this invention pertains is that of consumer electric motor-driven bicycles. The present invention is a system and methods for the implementation and construction of a unique electric bicycle built on a standard bicycle frame using unique drive and braking systems.

2. Description of the Prior Art

U.S. Pat. No. 8,183,726 relates to the methods, systems and apparatus for an electric motor assist bicycle having a hub motor mounted to the front or rear hub to provide electric motor assist, and to function as a generator to charge batteries. The motor can be either a molded or wound magnetic flux channel transverse wound stator permanent magnet motor. The bicycle hub motor includes an electronic controller mounted to the frame of the bicycle and coupled with feedback electronics for monitoring a timing, speed and direction and coupling a signal to a processing unit for adjusting the drive electronics driving the phase windings. The pedal crank arm housing of the electric motor assist bicycle can include battery access ports with batteries stacked inside the bicycle seat tube and the down tube and a strain gauge to measure the rider pedaling effort and produce a signal in response.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 8,205,705 relates to a middle electric motor drive unit for an electric bicycle, including a motor, a controller, a sensor, a gear reducer, a one-way clutch, a chain tightener, and a housing. The middle electric motor drive unit is disposed below a frame of the electric bicycle, and in the vicinity of a pedal shaft thereof. The middle electric motor drive unit is independent from the pedal shaft with respect to functions and structure. The motor is an internal rotor and permanent magnet DC motor. The motor shaft of the motor is parallel to a gear shaft and the pedal shaft. The controller is built-in, and disposed in or on the housing. The sensor is an internal sensor or an external pedal shaft sensor.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,934,576 relates to a bicycle frame, including a number of frame elements, preferably tubes, where the frame elements are interconnected and constitute a construction with so great rigidity that the cycle frame does not change its geometrical shape under usual load, where an electric battery system is at least partly embedded in the frame, including at least one battery pack for storing electric energy for use in connection with equipment, such as comfort equipment and/or safety equipment on a bicycle, including an electric auxiliary motor, where the part of the frame adapted to mounting a battery pack is constituted by a hollow section, the hollow section being a multiple chamber section, where a battery pack is predominantly arranged in a cutout in the multiple chamber section so that at least one chamber in the multiple chamber section is substantially intact. Thus is obtained a cycle frame with a cutout for a battery pack, where the frame has great rigidity.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,604,078 relates to an electric bicycle includes at least two internal storage compartments accessible by moving a seat to an open position. The storage compartments are arrange side-by-side and separated by a dead space (e.g., a wall). The electric bicycle includes a lock mechanism disposed in the dead space for selectively locking the seat in a closed position. As so arranged, the lock mechanism does not reduce the size of the two internal storage compartments and is less likely to be tampered with in comparison to lock mechanisms that are located around the perimeter of the storage compartments.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,342,321 relates to a bicycle electric power unit supplies electric power to a bicycle motor unit having a power source, a power source controller, a power source voltage detector, a first power source switch and a second power source switch. The power source controller turns off the first power source switch when the power source voltage detector detects a voltage of a specific value or less. The first power source switch supplies electric power to the power source controller when the power source is on and blocks the electric power to the power source controller when the power source is off. The first power source switch is turned off by the power source controller when the power source is on. The second power source switch is disposed between the power source and the motor unit. The second power source is turned on and off by the power source controller.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,273,123 relates to an electric bicycle power structure includes a motor, a power exchange device and pedal interlocking shafts; and provides power through the motor or the pedaling pedal interlocking shafts, wherein the power exchange device automatically switches between the motor and the pedal interlocking shafts to accomplish power saving effects. The power exchange device has a planet decelerating mechanism, a clutch and a chain wheel cover. The power exchange device is located between the motor and the pedal interlocking shaft and is capable of directly switching between these power generating devices. A chain is used to impel the gear and wheel at the chain wheel cover, and an existing transmission gear of the bicycle is employed for accomplishing transmission effects, thereby decreasing numbers of parts without changing designs of the bicycle to further reduce production costs.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,150,339 relates to an electrically powered bicycle including a rear fork assembly having a pair of structures extending from a frame, a wheel attached between the structures of the rear fork assembly, an electric motor mounted adjacent to the wheel, and a drive mechanism disposed between the electric motor and the wheel. The drive mechanism includes a first gear connected to a shaft of the electric motor and a second gear connected to the wheel. The first gear has a first set of teeth meshed with a second set of teeth of the second gear such that when the shaft of the electric motor turns, the second gear provides a rotating force to the wheel.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,261,175 relates to a power assisted bicycle which modifies an existing manually powered bicycle by replacing the left pedal crank arm with a motor-driven sprocket and left pedal assembly. An electric motor is attached to the bicycle's frame and has attached a motor drive sprocket and a one-way clutch. A motor roller chain ring is connected in concert to the motor drive sprocket and motor driven sprocket, such that the electric motor, provides a power assist to the manually powered bicycle, with the one-way clutch permitting unassisted pedaling without resistance of the motor when de-energized. An electrical power source interfaces with an electrical control system for supplying electrical energy to operate and control the electric motor.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 7,040,440 relates to an electric assisted bicycle of simple structure is provided which is superior in the stability, reliability, and certainty of operation, and is provided with an electric power regenerative function and a brake assist function. A pedal force transmitted from a crank shaft is transmitted to an axle shaft via first transmission means, and the output of a motor as an assistant motive power is transmitted to the axle shaft via a clutch unit, which can switch a lock direction in conjunction with brake operation by a cyclist, and second transmission means.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 6,923,355 relates to a bottle-cage supporting unit for a bicycle includes a cage support for the bottle, associated to which are a container for an electronic control unit for a motor-driven gear-shifting system with which the bicycle is equipped and a container for the electric power-supply battery for the electronic control unit.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 6,347,682 relates to a drive unit for a bicycle with an electric motor or a geared motor that may be affixed to a frame tube of the bicycle by means of a holder and with a toothed belt for transmission of the torque onto a sheave attached on a wheel of the bicycle. On its side that is turned away from the spokes, the sheave is provided with one or several radial projections to prevent the belt from running off. The sheave having a central opening is centered for concentricity with the axle of the wheel and is attached to the wheel spokes of the bicycle.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 6,155,369 relates to an electric bicycle assembly provided with a lightweight, high performance DC electric motor and a tuned centrifugal slip clutch assembly in combination therewith. This bicycle assembly includes a two-stage start-run electric control circuitry which prevents high motor zero rpm in-rush currents which may damage the motor. Another embodiment of this invention utilizes a variable ratio V-belt drive assembly having a centrifugal clutch capability so as to engage and disengage at a predetermined RPM. Another embodiment of this invention is provided with a front wheel mounted regenerating wheel rotor assembly which is adapted to recharge batteries as needed. Another embodiment of this invention utilizes a mechanically actuated multi-stage power control switch so as to selectively provide a start circuit and two or more power control levels in the operational use thereof.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 6,131,683 relates to an electric bicycle comprises a motor powered driving assembly including a flat type DC motor a speed reduction mechanism, a control circuit, a pedal load sensor, and a pedal rotation speed sensor which are integrally assembled together, the motor powered driving assembly being disposed adjacent a lower median portion of a body frame. Through this arrangement it is possible to provide an electric bicycle which affords ease of control and good riding comfort and has relatively low center of gravity.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

U.S. Pat. No. 6,011,366 relates to an electric bicycle comprising an electric motor mounted on the body of the bicycle between the saddle and the outer periphery of the rear wheel, and a belt transmission mechanism for transmitting the rotation of the motor to the rear wheel on speed reduction. The belt transmission mechanism comprises a drive pulley provided between the saddle and the outer periphery of the rear wheel for receiving the power of the motor, a driven pulley having the same diameter as the rim of the rear wheel and rotatable with the rear wheel alongside the rim, and a belt around the drive pulley and the driven pulley. These components realize a simple construction wherein the rotation of the motor can be transmitted to the rear wheel as reduced to the desired speed in a smaller number of stages.

This patent does not teach a system and method of encasing the drive components in a unified storage device compressed and structurally integrated into the triangle space between the top tube, down tube and seat tube of a typical bicycle frame. This patent also does not teach the brake conversion system used to mount high-power brake systems typically used on mountain bikes such as but not limited to cantilever rim brakes and disc brakes, to a standard road bike frame. Nor does this patent teach the reinforced custom brake brackets used to improve the braking power and durability of stock cantilever rim brakes. This patent also does not teach a way of eliminating the crank, pedal and chain drive system and replacing with fixed mounted foot pegs to the bottom bracket of the bicycle frame.

### SUMMARY OF THE INVENTION

The present invention is a unique system and method for adapting an electric hub motor and component kit to a standard or custom bicycle platform in a manner that optimizes the performance, handling and safety of the constructed electric bike. This invention details a unique component case that provides the storage and security of electric bicycle drive components including the electric power source (the battery cell pack), and electric motor controller including circuit board and housing, along with associated wires, fuses, switches, instruments and plugs. The invention also provides a method of attachment and integration of stated components to a typical bicycle frame in a manner that encases the drive components in a unified storage device that is then compressed and structurally integrated into the triangle space between the top tube, down tube and seat tube of a typical bicycle frame.

This invention also details a unique braking system that adapts high power brakes (typically used for mountain bike applications) to mount to a standard road bike frame. The braking system also includes unique mounts and brackets to improve braking power and add stiffness and durability to the brake components.

This invention also details a method of mounting stationary foot pegs in the bottom bracket of a typical frame and replacing the standard pedals and crank set.

Benefits of the current invention include:

The invention solves and improves many of the deficiencies and offers a unique alternative to the existing methods of electric drive component storage and attachment.

First, the case and drive components are mounted entirely within the triangle of the frame. This improves stability and maneuverability by locating the added weight of the components low and directly under the rider's center of gravity. This location also offsets and balances the weight of the hub motor located in the rear wheel. Furthermore all components are centered side to side within the frame, again adding balance and stability to the bike. For overall design integration, locating the drive components centrally within the frame triangle allows for easy wire management and distribution and maintains a clean, finished, professionally designed appearance. It also allows aftermarket paniers, baskets, lights and fenders to be mounted the same as on any standard bicycle.

The primary improvement over other electric bike component storage methods is how the invention houses and secures the components. Rather than components ‘floating’ inside a box or bag, or directly fastened to the bike frame at a couple points, this case encapsulates the components and integrates them into the entire component case assembly. This method is beneficial because the loads of the impacts occurring during riding are transferred uniformly around the components rather than to a few critical attachment points. In other words, the case dampens the vibration and impact associated with everyday cycle use and protects and secures the components it houses. Since the components are integrated into the case, it makes it much harder to steal the components. One would have to completely disassemble the case to pull out the battery or controller. Locating the component case inside the triangle of the bike frame frees up and creates space that allows for modification. The additional room allows the user or builder the flexibility to configure different size battery packs, controllers and provides a place to attach instruments, fuses and other associated components.

A unique aspect of the invention is how the entire component case assembly attaches to the bicycle. Where prior methods of attachment either bolt to the frame or are welded to brackets during manufacturing, or rely on a custom shaped oversize frames to house the components, this invention uses a simple non-invasive compression method to mount to a standard bike frame. The benefits and improvement over prior designs is significant by allowing the component case to securely attach to the bike frame without any modifications to the frame. This approach saves money and time in manufacturing reducing overall costs. Methods employed by other electric bikes including drilling, tapping threads, cutting or welding a bike frame creates weak spots in the frame that can crack and cause harm and injury. For example, aluminum bicycle frames, which are lighter and increasingly popular, cannot be welded properly without a long complicated heat treating process. Also if the typical battery boxes bolted or welded to the frame are directly impacted, they can bust off at those points and cause permanent damage to the frame. With this invention the case is compressed across the entire surface of the frame, distributing any loads or impact, making it difficult for a single point of damage. This holds true for the impacts and loads associated with everyday riding. The case is compressed at all sides to form to the shape of the frame, spreading loads and impacts and dampening vibrations of the bike. This non-invasive method of attachment also allows the user to take out the electric drive components if they wish and still have a completely functioning, standard bicycle. It also adds flexibility to fit to other frame sizes and shapes with minor modifications allowing customers to retrofit their own individual bikes.

It is therefore a primary object of the present invention to provide a unique alternative and improvement on other devices and methods of creating electric powered bicycles.

It is another object of the present invention to provide a unique alternative and improvement on other devices systems and methods used for electric bike drive components by eliminating the need for a drive shaft or drive chain by housing the motor directly to the front or rear wheel axle.

It is another object of this invention to exploit the inherent triangular geometry of the bicycle frame to embody an immovable casing for the drive components without the need for mechanical fastening or securing so that force vectors cannot act on the casing.

It is another object of this invention to provide a system and method of encasing the drive components in a unified storage device compressed and structurally integrated into the triangle space of a typical bicycle frame between the top tube, down tube and seat tube.

It is another object of the present invention to provide a unique alternative and improvement on other devices and methods used for the attachment of electric bike drive components.

It is another object of the present invention to provide a decorative and protective casing for the stored electric drive components. There are several embodiments based on various material and methods of fabrication including but not limited to: vacuum formed or injection molded plastic and composites, also fiberglass or carbon fiber molds, also stamped metal.

It is another object of the present invention that the casing side covers to provide optimal and improved aerodynamic performance based on reducing wind resistance and drag.

It is another object of the present invention to provide to provide a minimal cross sectional profile for enhanced ergonomic performance and rider comfort and also improved aerodynamics.

It is another object of the present invention to embody a symmetrical system that balances the drive components laterally. All components are centered side to side within the frame adding balance and stability to the bike

It is another object of the present invention to improve stability and maneuverability by locating the added weight of the components low and directly under the rider's center of gravity.

It is another object of the present invention to provide design integration by locating the drive components centrally within the frame triangle which allows for easy wire management and distribution and maintains and allows for a clean, finished, professionally designed appearance.

It is another object of the present invention to primarily use standard bicycle parts and components allowing for personal customization and fitting, as well as minimal, consolidated location of electric drive component for use of typical aftermarket accessories including paniers, baskets, lights and fenders.

It is another object of the present invention to provide a component storage method that uniquely houses and secures the components. Rather than components ‘floating’ inside a box or fastened to the bike at a couple points, this case encapsulates the components and integrates them into the entire component case assembly.

It is another object of the present invention to create an embodiment of the invention where the load of impacts and vibrations are transferred uniformly around the components rather than to a few critical attachment points. In other words, the case dampens the vibration and impact associated with everyday cycle use and protects and secures the components it houses.

It is another object of the present invention to create an embodiment of the invention that makes it much harder to steal the components since the components are integrated into the case. A thief would have to completely disassemble the case to pull out the battery or controller.

It is another object of the present invention to create an embodiment of the invention that allows for modification, replacement and upgrade of the components. The invention allows the user or builder to configure different size battery packs, controllers and provides a place to attach instruments, fuses and other associated components and gauges.

It is another object of the present invention to create a unique method of how the entire component case assembly attaches to the bicycle by using compression to mount to a standard bike frame.

It is another object of the present invention to create a unique system that allows the component case to securely attach to the bike frame without any modifications to the frame.

It is another object of the present invention to create a unique system that allows the cooling of the motor controller by locating the motor controller towards the front of the bike and directing forced air through vents in the side covers.

It is another object of the present invention to create a unique case which is compressed across the entire surface of the frame, distributing any loads or impact, making it difficult for a single point of damage.

It is another object of the present invention to create a non-invasive method of attachment that allows the user to take out the electric drive components if they wish and have a completely functioning standard bicycle. It also adds flexibility to fit to other frame sizes and shapes with minor modifications.

It is another object of the present invention to create a system that can be used as a kit to retrofit existing bicycles.

It is another object of the present invention to create a unique system and method for adapting high power brakes including but not limited to: cantilever brakes and disc brakes to a standard road bike frame without the need for frame modification or brazing on new bosses, tabs or brackets.

It is another object of the present invention to create a unique stationary foot peg system that replaces the pedals and crank set and mounts inside the bottom bracket of a typical bicycle frame.

These and other objects of the present invention will become apparent to those skilled in this art upon reading the accompanying description, drawings, and claims set forth herein.

### BRIEF DESCRIPTION OF THE DRAWINGS

There are four subsystems of components that constitute the unified components system and casing enclosure that are detailed sequentially in FIGS. 1-4. The Figures for each of the four subsystems include an elevation and a cross section diagram describing the relationship to the overall bike frame. Also in the description of drawings, are system diagrams, elevations and cross-sections of the rear high-power brake adapters (FIGS. 6 and 6A) and the foot peg (FIGS. 5 and 5A) adapter plugs to replace the crank set and pedals.

FIG. 1 is a systems diagram and elevation detailing the best mode of the mounting block sub system of the present invention. The figure shows the mounting blocks encasing the drive components and compressing and unifying them within the triangle structure of the bike frame.

FIG. 1A is a cross section, related to FIG. 1, of the mounting block sub system of the present invention. The figure illustrates the milled grooves of the mounting blocks that lock the blocks and the encased components to the bike frame.

FIG. 2 is a systems diagram and elevation detailing the best mode of the case panel sub system of the present invention. The figure shows the case panels sandwiching the mounting blocks and encasing the drive components in turn compressing and further unifying them within the triangle structure of the bike frame.

FIG. 2A is a cross section, related to FIG. 2, detailing the case panel sub system of the present invention. The figure illustrates the fastening of the case panels to the mounting blocks that lock the blocks and the encased components to the bike frame.

FIG. 3 is a systems diagram and elevation detailing the best mode of the component bracket sub system of the present invention. The figure shows the component brackets securing and locking the drive components to the component case.

FIG. 3A is a cross section, related to FIG. 3, detailing the component bracket sub system of the present invention. The figure illustrates the fastening of the component brackets through the case panels and into the mounting blocks to secure and lock the drive components to the component case.

FIG. 4 is a systems diagram and elevation detailing the best mode of the side cover sub system of the present invention. The figure shows the side covers encasing and protecting the drive components and related wiring, switches, fuses and miscellaneous hardware.

FIG. 4A is a cross section, related to FIG. 4, detailing the side cover sub system of the present invention. The figure illustrates the fastening of the side covers to the side cover stand-offs and sealing and encasing the drive components and other sub systems.

FIG. 5 is a systems diagram/elevation showing the best mode of the foot peg adapter plug to replace the crank set and pedal drive. It shows the foot pegs located in the bottom bracket of a typical bike frame.

FIG. 5a is a cross-section and elevation of the foot peg adapter plugs mounted inside the bottom bracket of the frame. It also shows the foot peg plugs screwed into the threaded stud on each side of the bottom bracket and the foot pegs fastened to the threaded stud.

FIG. 6 is a system diagram/elevation showing the assembly of the high-power brake adapter and brace located on the rear frame seat stays. The drawing illustrates a cantilever brake assembly attached to cantilever brake bosses fastened to the brake adapter/brace. It also shows the attachment of the entire unit to the seat stay cross member of the frame and also secured to each seat stay with adjustable clamps.

FIG. 6A is an enlarged elevation showing the detail of the related components of the cantilever brake assembly and the location and method of attachment to the seat stays of a typical bike frame.

### DETAILED DESCRIPTION OF THE INVENTION

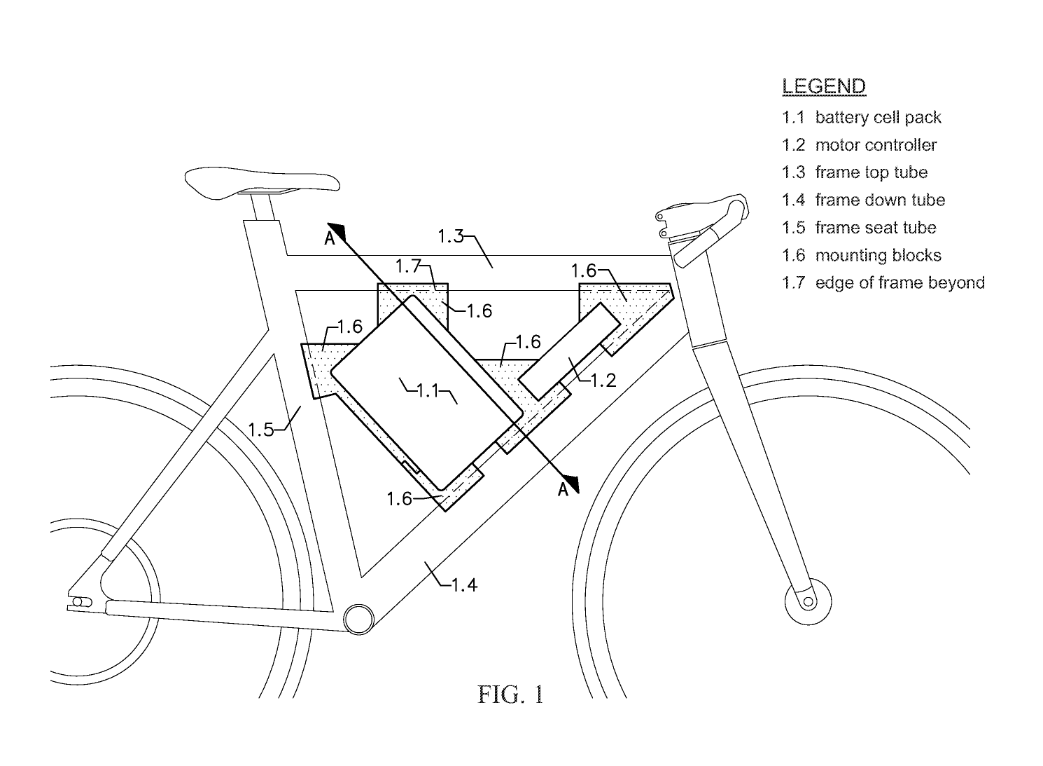

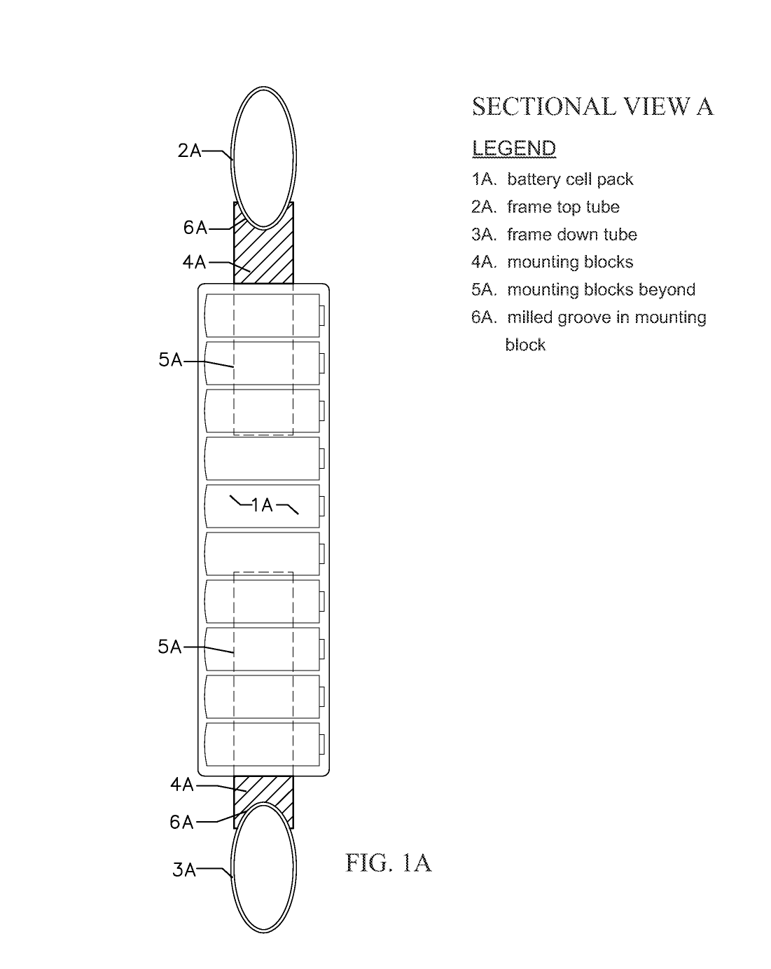

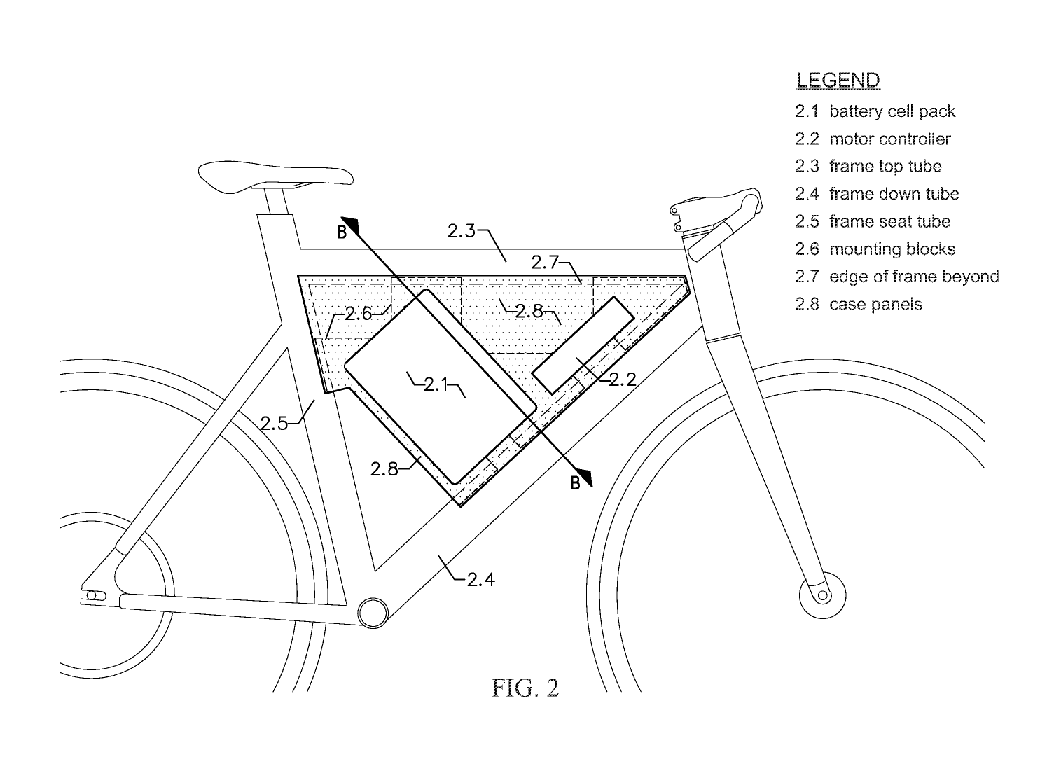

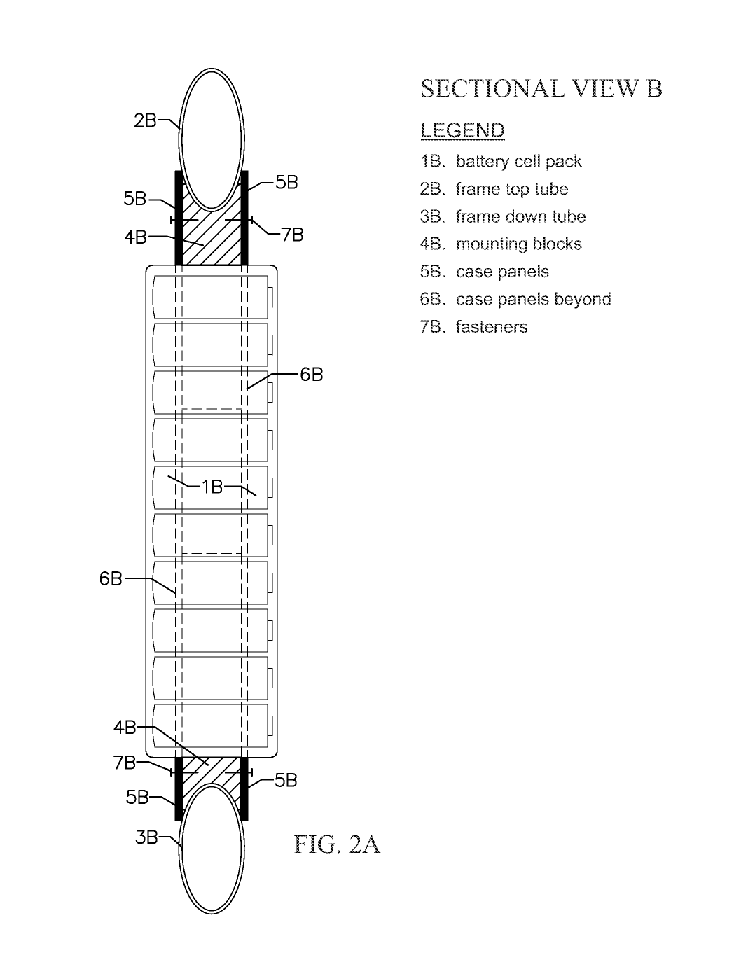

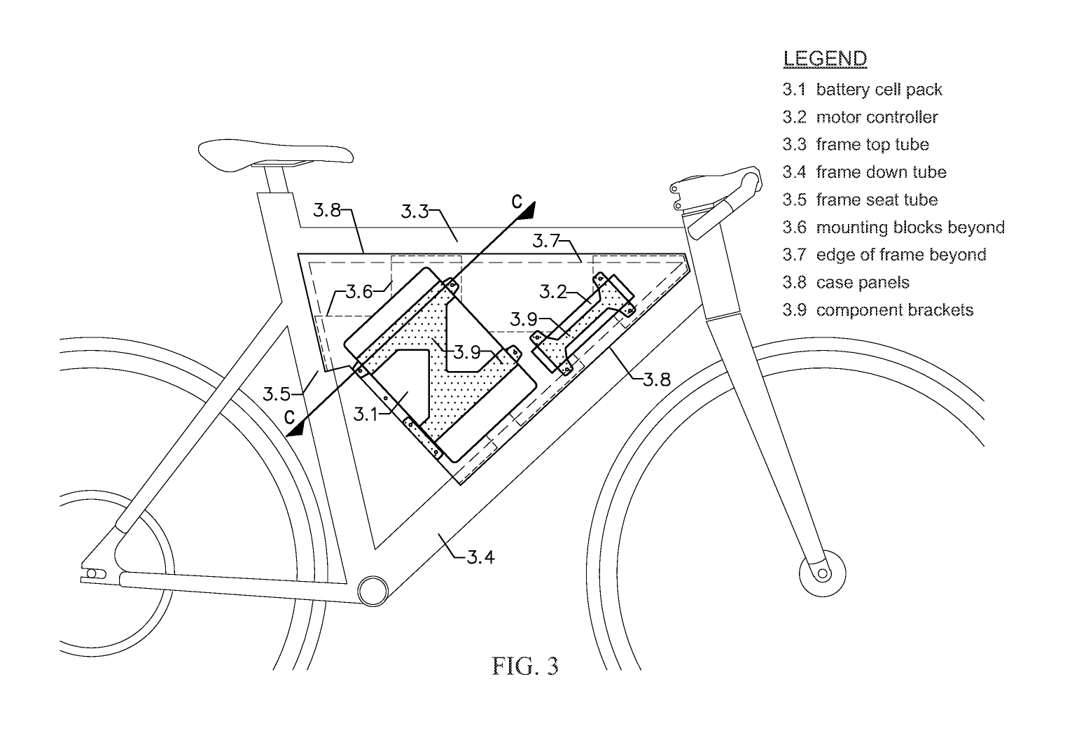

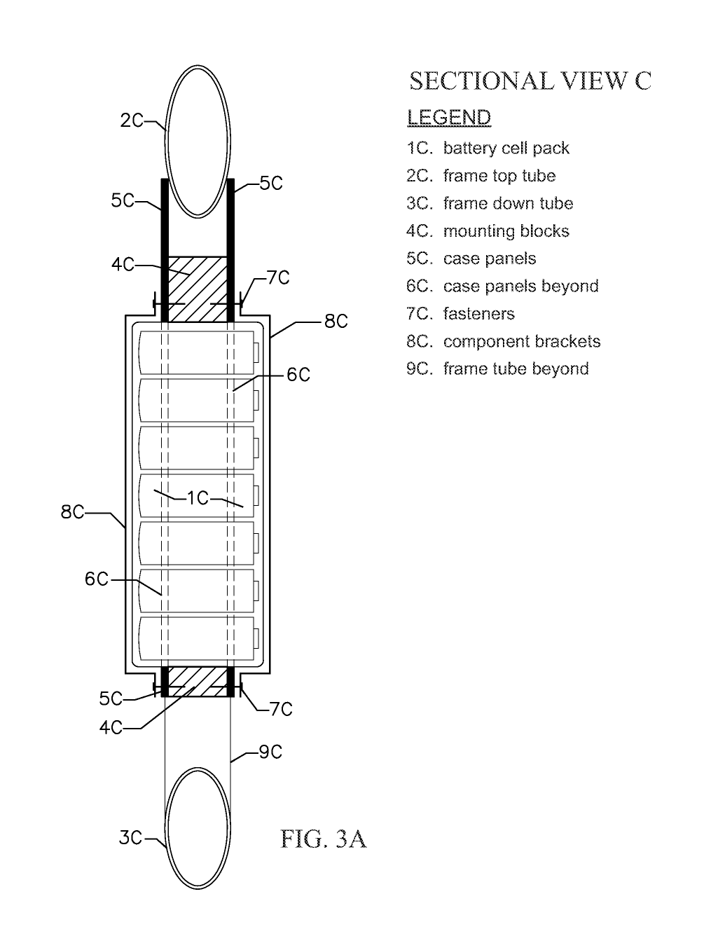

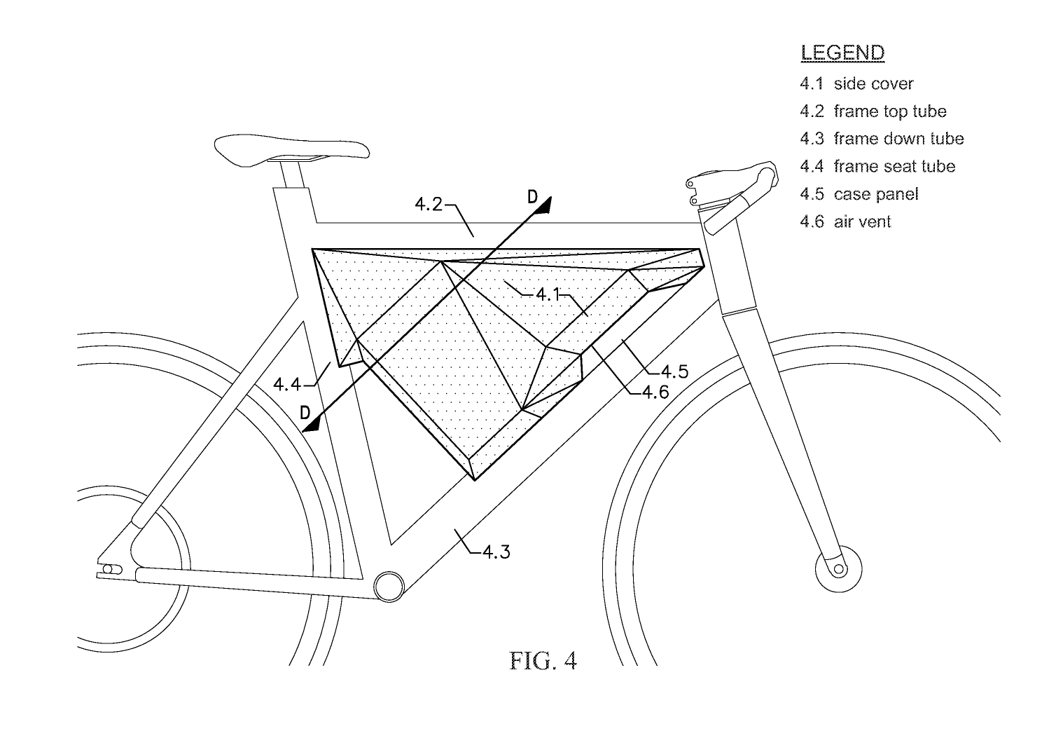

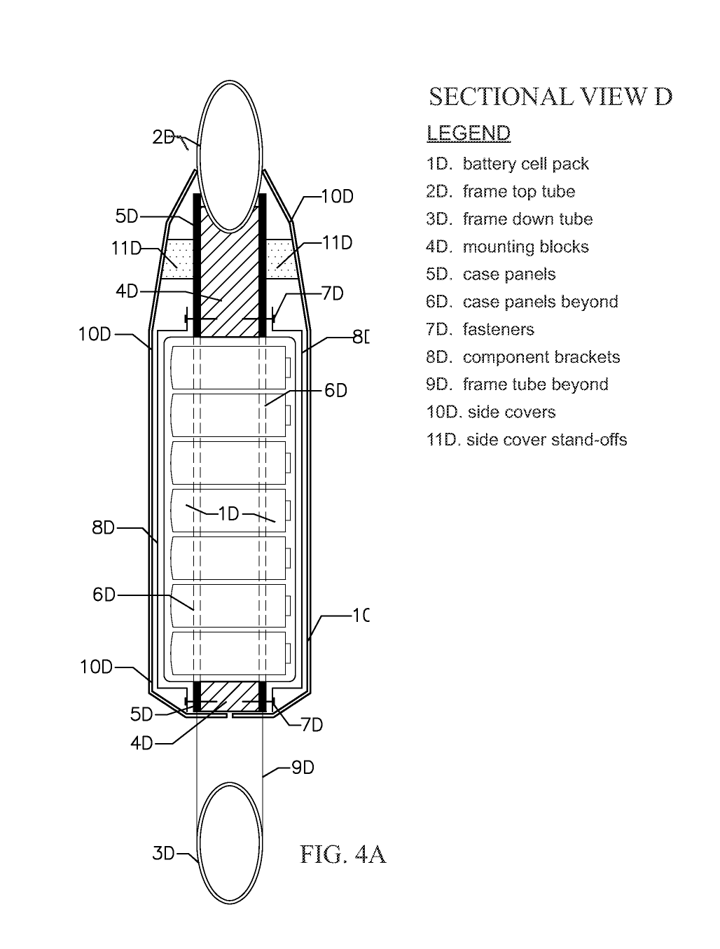

The component case houses, secures and provides the best mode of the invention and the primary method of attachment for the two major electric drive components—the power cell source or battery (1.1 FIG. 1) and the motor controller (1.2 FIG. 1). It also houses all the associated wires, fuses, switches and plugs. The component case is made of four primary sets of parts or subsystems. These are (in order of assembly): the mounting blocks (detailed in FIGS. 1 and 1A), the case panels (detailed in FIGS. 2 and 2A), the component brackets (detailed in FIGS. 3 and 3A), and the side covers (detailed in FIGS. 4 and 4A). Parts also include various hardware including but not limited to: fasteners, ties and clamps.

The first subsystem is the mounting blocks (detailed in FIGS. 1 and 1A). These blocks make-up the core of the case assembly and provide the primary means of locking the components into the triangle of the frame. The blocks once mounted and structurally unified act as the ‘back bone’ of the entire component case. Each block is cut and milled to a specific shape (1.6A FIG. 1A) and acts as both a wedge to lock the component onto the frame and a spacer to properly locate and register the components correctly inside the triangle of the bike frame (1.3, 1.4 & 1.5 FIG. 1). The mounting blocks are located generally at the corners of the battery pack (1.1 FIG. 1) and motor controller (1.2 FIG. 1) and are tightly wedged between the component and the frame. The components are secured and locked into the frame by compression and the mass of the components and each subsequent subsystem layer reinforces this compression. Grooves at the blocks (1.6A FIG. 1A) conform to the profile of the frame it is attaching to. When the components are locked into place these grooves prevent the entire case and attached components from moving laterally (side-to-side), up and down, or forward or backwards. Once the component case is assembled, the material properties of the blocks also provide shock and vibration dampening transmitted from the frame during riding.

Once the blocks are in place and the drive components are in position, the case panels (as detailed in FIGS. 2 and 2A) are installed. The two case panels are cut to the shape of the bike frame triangle at the perimeter while the interior of the panels have two cut-outs in the shape of the battery pack and motor controller. Other small holes are placed into the panels for mounting accessory items like switches and plugs, and also for routing wires, hoses and cables. Each panel is then inserted on each side of the frame over the battery pack and controller and fastened into the mounting blocks (as detailed in FIG. 2A). The panel assembly can be manufactured to accommodate different size components. At this point the whole component case is structurally unified and locked into the bike frame triangle. The case panels join all the mounting blocks together and they cannot shift, loosen or rattle over time and use. Furthermore the fastened panels provide a tight, rigid compression of the case, sandwiching against the frame and preventing further lateral movement. The component case cannot be taken out or stolen without disassembling the panels from the mounting blocks. Also any internal loads from the components or outside bumps and vibrations are transferred uniformly across the entire case, via the case panel. Finally the case panels provide a mounting surface for the clips, case brackets and stand-offs for the side covers (as detailed in FIG. 4A). The components are mounted symmetrically which balances the drive components laterally. This also provides improved stability and maneuverability by locating the added weight of the components low and directly under the rider's center of gravity.

After the case panels are fastened to the mounting blocks, the component brackets are secured over the components (as detailed in FIGS. 3 and 3A). The component brackets are cut and bent to form around its respective component. There are a total of four brackets, two on each component on the left and right sides of the component case. The brackets are mechanically fastened at the bracket tabs through the case panels and into the mounting blocks (as detailed in FIG. 3A), adding further structural integrity to the case. The brackets provide additional lateral bracing of the components, as well as security and theft protection. They also provide some side impact protection of the components.

Finally the side covers are installed (as detailed in FIGS. 4 and 4A). The primary function of the side covers is to further protect the drive components from dirt, debris and moisture, as well as aesthetically finishing the look of the case. Graphics and logos will cover the surface of the side covers and provide a layer of scratch and UV protection of the covers. The side covers consist of two shells, one on each side of the bike frame, completely covering the component case (as detailed in FIG. 4A). The shells are made of plastic, aluminum or composite sheets that are cut and formed to mold to the shape of the components. The side covers are fastened to the case panel and tightly held against the frame and perimeter of the component case and provide moisture and weather protection. The front of each side cover where it surrounds the motor controller is flared out and provides air venting and cooling of the controller (4.5 FIG. 4). The case also has openings for access to switches and instruments such as the battery indicator. The style of the covers serves both form and function. The triangulated facets of the cover look ‘stealthy’ and sleek while providing rigidity and lateral strength to the covers. The case also provides improved aerodynamics and ergonomic efficiency. This assembly can also be used as a retrofit kit for existing bicycles.

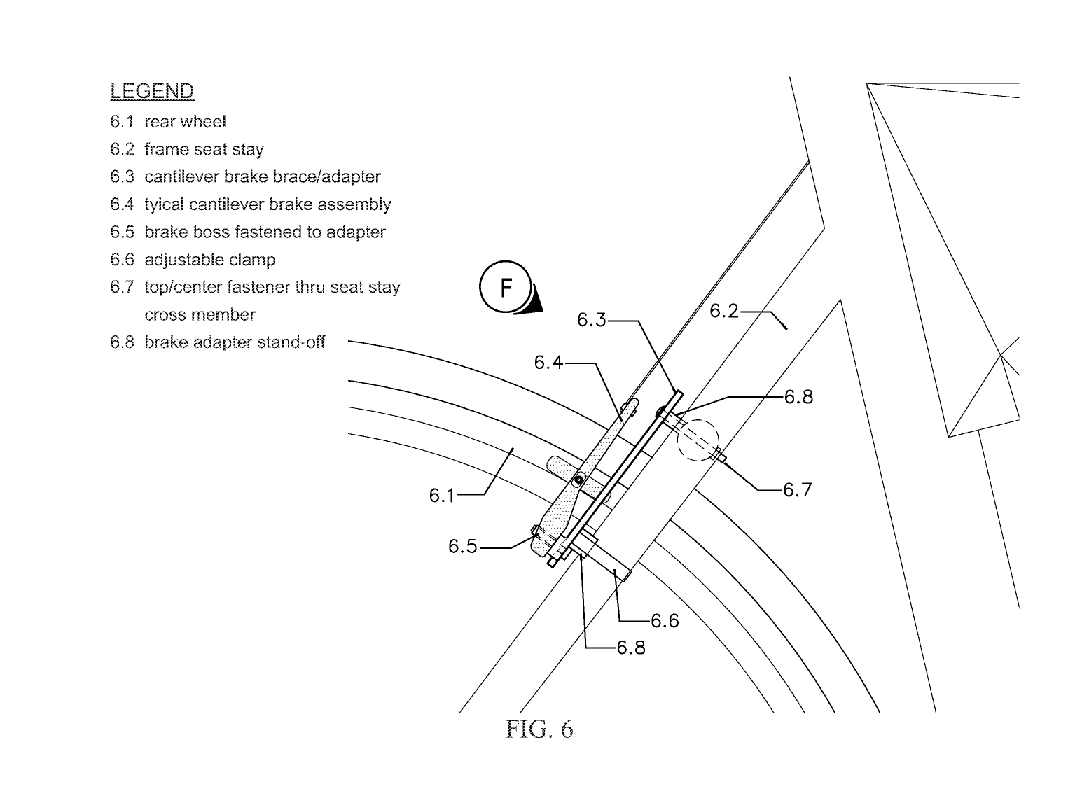

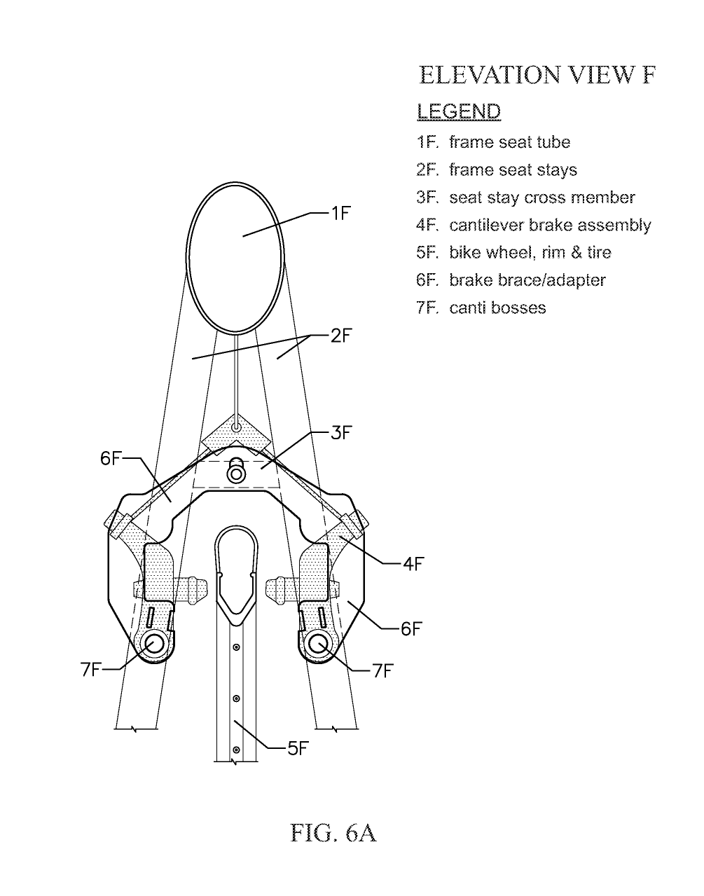

The invention also includes a unique system and method for adapting high-power cantilever brakes to the back of a typical road bike frame without needing any frame modification or cantilever brake bosses brazed to the seat stays (FIGS. 6 and 6A). Instead the invention has cantilever brake bosses mounted to a custom reinforced bracket (6.5 FIG. 6) that is then bolted to the single mounting point at the top of the seat stays (6.7 FIG. 6) where caliper style brakes would typically be mounted. The bracket is further reinforced to the back of the frame on each seat stay where the bosses would typically be, by clamping the custom bracket to the seat stays with adjustable clamps or straps (6.6 FIG. 6). This prevents the entire rear cantilever brake assembly from pivoting about the top-center mounting point, it locks the brakes to the frame, and allows the loads and stresses of braking to be transferred to multiple points on the frame. The bracket also resists the forces of the brake calipers from spreading out when the brakes are applied, adding more power and stability and improving brake modulation.

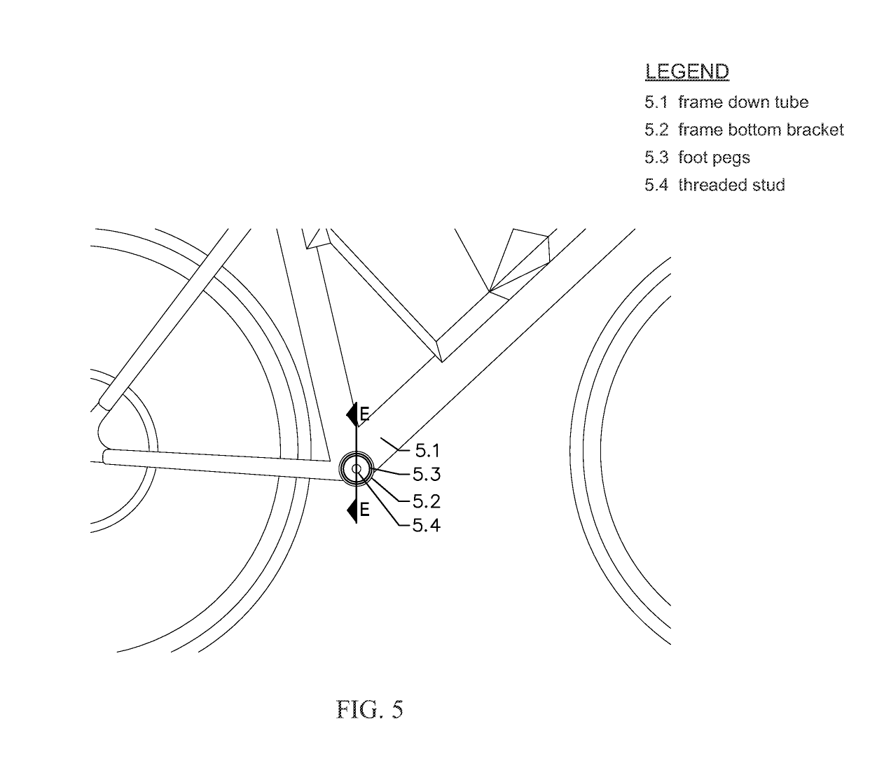

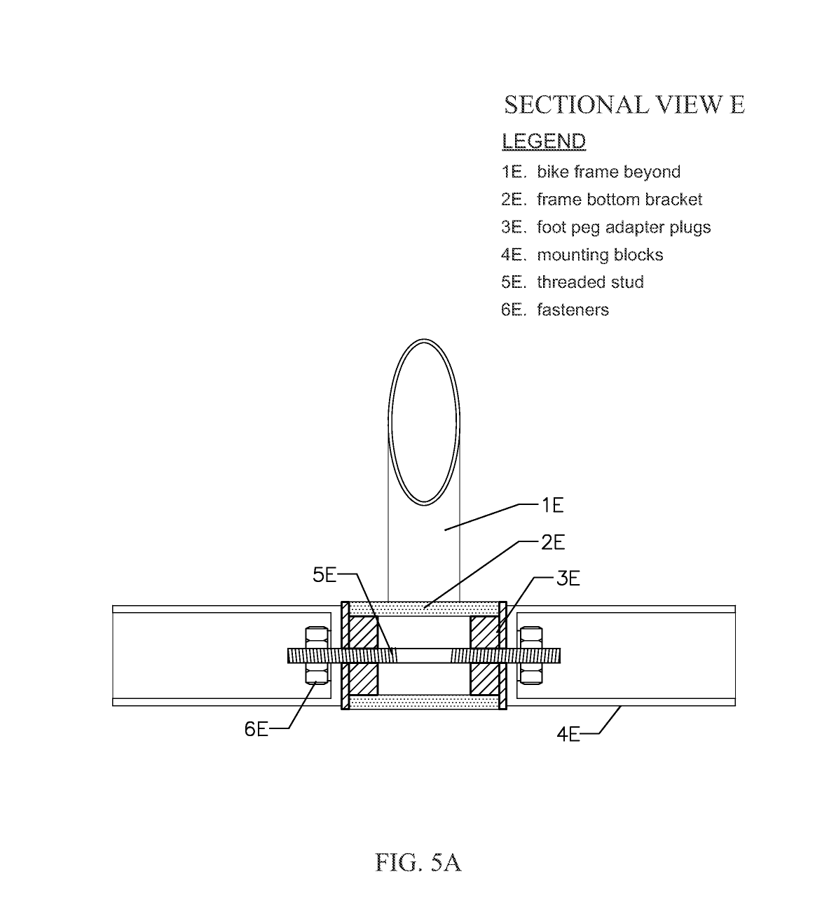

The invention also includes a unique system and method for mounting stationary footpegs to the frame, and replacing the pedals and crankset (FIGS. 5 and 5A). Due to the high power output of the electric motor and drive, pedaling is no longer necessary. The pedal/chain drive can be completely removed and the invention allows the rider to instead stand on footpegs much like riding on a motorcycle. The footpeg mounting system consists of two plugs machined to fit directly into each side of the bottom bracket of the frame (3E FIG. 5A). A heavy duty threaded stud is threaded through the center of each plug and projects out of each side to receive the footpegs (5E FIG. 5A). The threaded stud also allows each plug to be tightened do the frame, effectively sandwiching tight to the bottom bracket (6E FIG. 5A). Once the plugs are tightened, footpegs are fastened to the protruding threaded stud. With the rider standing on the footpegs they are able to maintain good control of the bike during cornering and are also able to stand up off the seat when riding over rough terrain.

What is claimed is:

1. A System for encasing the drive components of an electric powered bicycle in a unified storage device compressed and structurally integrated into the triangle space of a typical bicycle frame between the top tube, down tube and seat tube.

2. A system according to claim 1 that exploits the inherent triangular geometry of the bicycle frame to embody an immovable casing for the drive components without the need for mechanical fastening or securing so that force vectors cannot act on the casing.

3. A system according to claim 1 for the attachment and storage of electric bike drive components in a secure, structurally unified case.

4. A system according to claim 1 that attaches the entire component case assembly to the bicycle by using compression to mount to a standard bike frame without fasteners or frame modification. The case compresses by sandwiching and squeezing the bicycle frame laterally. The case also compresses by wedging the mass of the components into the triangle shape of the frame preventing movement and shifting of the components.

5. A system according to claim 1 to embody a symmetrical system that balances the drive components laterally. All components are centered side to side within the frame adding balance and stability to the bike

6. A system according to claim 1 to improve stability and maneuverability by locating the added weight of the components low and directly under the rider's center of gravity.

7. A system according to claim 1 to provide design integration by locating the drive components centrally within the frame triangle which allows for easy wire management and distribution and maintains and allows for a clean, finished, professionally designed appearance.

8. A system according to claim 1 to provide a component storage method that uniquely houses and secures the components. Rather than components ‘floating’ inside a box or fastened to the bike at a few critical attachment points, this case encapsulates the components and integrates them into the entire component case assembly.

9. A system according to claim 1 to create an embodiment of the invention where the load of impacts and vibrations are transferred uniformly around the components rather than to a few critical attachment points. In other words, the case dampens the vibration and impact associated with everyday cycle use and protects and secures the components it houses.

10. A system according to claim 1 to create an embodiment of the invention that makes it much harder to steal the components since the components are integrated into the case. A thief would have to completely disassemble the case to pull out the battery or controller.

11. A system according to claim 1 to create an embodiment of the invention that allows for modification, replacement and upgrade of the components. The invention allows the user or builder to configure different size battery packs, controllers and provides a place to attach instruments, fuses and other associated components and gauges.

12. A system according to claim 1 to create a unique case which is compressed across the entire surface of the frame, distributing any loads or impact, making it difficult for a single point of damage.

13. A system according to claim 1 to create a non-invasive method of attachment that allows the user to take out the electric drive components if they wish and have a completely functioning standard bicycle. It also adds flexibility to fit to other frame sizes and shapes with minor modifications.

14. A system according to claim 1 to provide a decorative and protective casing for the stored electric drive components. There are several embodiments based on various material and methods of fabrication including but not limited to: vacuum formed or injection molded plastic and composites, also fiberglass or carbon fiber molds, also stamped metal.

15. A system according to claim 1 that creates casing side covers to provide optimal and improved aerodynamic performance by reducing wind resistance and drag.

16. A system according to claim 1 to provide a minimal cross sectional profile for enhanced ergonomic performance and rider comfort and also improved aerodynamics.

17. A system according to claim 1 that allows the cooling of the motor controller by locating the motor controller towards the front of the bike and directing forced air through vents in the side covers.

18. A system according to claim 1 to primarily use standard bicycle parts and components allowing for personal customization and fitting, as well as minimal, consolidated location of electric drive component for use of typical aftermarket accessories including paniers, baskets, lights and fenders.

19. A system according to claim 1 to create a system that can be used as a kit to retrofit existing bicycles.

20. A Method for making an electric bicycle comprising the steps of:
creating an initial subsystem that is the mounting blocks which make-up the core of the case assembly and provides the primary means of locking the components into the triangle of the bicycle frame;
once the mounting blocks are in place and the drive components are in position, the two case panels are cut to the shape of the bike frame triangle at the perimeter and are installed while the interior of the panels have two cut-outs created in the shape of the battery pack and motor controller;
holes are then placed into the panels for mounting accessory items like switches and plugs, and also for routing wires, hoses and cables;
after the case panels are fastened to the mounting blocks, the component brackets are cut and bent to form around the respective components and are secured over the components;
the side covers are fabricated by vacuum molding plastic or cutting and bending aluminum and are then installed over the component casings.

21. A method according to claim 20 wherein an immovable casing for the drive components is added into the inherent triangular geometry of the bicycle frame without the need for mechanical fastening or securing so that force vectors cannot act on the casing.

22. A method according to claim 20 wherein the electric bike drive components are attached in a secure, structurally unified case.

23. A method according to claim 20 wherein the entire component case assembly attaches to the bicycle by using compression to mount to a standard bike frame without fasteners or frame modification.

24. A method according to claim 20 wherein all components are centered side to side within the frame adding balance and stability to the bike in a symmetrical system that balances the drive components laterally

25. A method according to claim 20 wherein stability and maneuverability are improved by locating the added weight of the components low and directly under the rider's center of gravity.

26. A method according to claim 20 wherein the drive components are located centrally within the frame triangle which allows for easy wire management and distribution and maintains and allows for a clean, finished, professionally designed appearance.

27. A method according to claim 20 wherein the components are encapsulated and integrated into the entire component case assembly instead of ‘floating’ inside a box or fastened to the bike at a few critical attachment points.

28. A method according to claim 20 wherein the load of impacts and vibrations are transferred uniformly around the components rather than to a few critical attachment points.

29. A method according to claim 20 wherein the components are integrated into the case in such a manner as to make it much harder to steal the components since a thief would have to completely disassemble the case to pull out the battery or controller.

30. A method according to claim 20 wherein the case is created in such a manner that allows for modification, replacement and upgrade of the components.

31. A method according to claim 20 wherein the case is compressed across the entire surface of the frame, distributing any loads or impact, making it difficult for a single point of damage.

32. A method according to claim 20 wherein the non-invasive attachment of the casing allows the user to take out the electric drive components if they wish and have a completely functioning standard bicycle.

33. A method according to claim 20 wherein a decorative and protective casing for the stored electric drive components is added over the components of which there are several embodiments based on various materials and methods of fabrication including but not limited to: vacuum formed or injection molded plastic and composites, also fiberglass or carbon fiber molds, also stamped metal.

34. A method according to claim 20 wherein casing side covers are created and installed to provide optimal and improved aerodynamic performance by reducing wind resistance and drag.

35. A method according to claim 20 wherein casing side covers are created and installed to provide a minimal cross sectional profile for enhanced ergonomic performance and rider comfort and also improved aerodynamics.

36. A method according to claim 20 wherein the cooling of the motor controller is enhanced by locating the motor controller towards the front of the bike and directing forced air through vents in the side covers.

37. A method according to claim 20 wherein standard bicycle parts and components are used allowing for use of typical aftermarket accessories including paniers, baskets, lights and fenders.

38. A method according to claim 20 wherein the system can be used as a kit to retrofit existing bicycles.

39. A System for adapting high power brakes including but not limited to: cantilever brakes and disc brakes to a standard road bike frame without the need for frame modification or brazing on new bosses, tabs or brackets.

40. A Method for adapting high power brakes including but not limited to: cantilever brakes and disc brakes to a standard road bike frame without the need for frame modification or brazing on new bosses, tabs or brackets.

41. A System to create a unique stationary foot peg system that replaces the pedals and crank set and mounts inside the bottom bracket of a typical bicycle frame.

42. A Method to create a unique stationary foot peg system that replaces the pedals and crank set and mounts inside the bottom bracket of a typical bicycle frame.
